(19) United States
(12) Patent Application Publication
(10) Pub. No.: US 2025/0353197 A1
(43) Pub. Date: Nov. 20, 2025

(54) ROTATING LOCK MECHANISM FOR OUT-THE-FRONT (OTF) KNIVES

(71) Applicant: Hawk Designs Inc., Idaho City, ID (US)

(72) Inventor: Gavin Dan HAWK, Idaho City, ID (US)

(21) Appl. No.: 19/207,032

(22) Filed: May 13, 2025

Related U.S. Application Data
(60) Provisional application No. 63/647,496, filed on May 14, 2024.

(51) Int. Cl. B26B 1/08

(52) U.S. Cl. CPC B26B 1/08

(57) ABSTRACT

A knife includes a handle, a blade, and a lock rotatable to selectively lock the blade in the open position and selectively lock the blade in the closed position. The handle has a first locking surface and a second locking surface. The lock is rotatably supported upon a tang of the blade. The lock includes a protrusion having a first surface and a second surface. Rotation of the lock in the open position engages the first surface of the protrusion with the first locking surface of the handle to lock the blade in the open position. Rotation of the lock in the closed position engages the second surface of the protrusion with the second locking surface of handle to lock the blade in the closed position.

### CROSS-REFERENCE TO RELATED APPLICATION

This application, under 35 U.S.C. S 119, claims the benefit of U.S. Provisional patent application Ser. No. 63/647,496 filed on May 14, 2024 and entitled “Rotating Lock Mechanism For Out-The-Front (OTF) Knives,” the contents of which are hereby incorporated by reference in its entirety.

### TECHNICAL FIELD

The present disclosure relates to locking mechanisms for knives, particularly to rotating lock mechanisms for selectively locking the blade of out-the-front (OTF) knives.

### BACKGROUND

OTF knives are well-known for their ability to deploy and retract a blade from the front of the handle via a user-operated mechanism. Traditional designs often use complex arrangements of springs, bars, and multiple locking components to secure the blade in both open and closed positions. These mechanisms, while functional, can involve numerous moving parts, which can complicate manufacturing processes, increase costs, and affect reliability due to potential mechanical failures. There exists a need for a simplified yet robust locking mechanism that minimizes parts and maximizes functionality and durability. Other drawbacks, inefficiencies, and issues may also exist with current OTF blade securing mechanisms. Other disadvantages may exist.

### SUMMARY

The present disclosure includes embodiments that may mitigate some of the disadvantages discussed above. Disclosed embodiments include a novel rotating lock mechanism designed to simplify the blade locking system of OTF knives. This mechanism utilizes a rotatable element connected to the blade's tang, which engages with profiles in the handle to secure the blade in open and closed positions effectively. Embodiments of the rotatable element may include multiple engagement features, such as protruding profiles, bosses, or other extensions, that interact with corresponding features in the stop plate. Among other things, the disclosed embodiments allow for a more streamlined, reliable locking mechanism that is easier to manufacture and maintain.

An embodiment of a knife includes a handle, a button, a blade, a thrust mechanism, a lock, and a stop plate. The handle has a first end and a second end. The button is moveable along the handle. The blade has an integral tang. The blade and the tang are moveable between a closed position and an open position. The blade and the tang are positioned within the handle in the closed position, and the blade extends from the first end of the handle in the open position.

The thrust mechanism is configured to move the blade between the closed position and the open position. The lock is rotatably supported on the tang of the blade and configured to rotate about an axis of rotation. The lock has a protrusion offset from the axis of rotation of the lock. The stop plate includes a first end, a second end, a first portion associated with the first end of the stop plate, a second portion associated with the second end of the stop plate, and a slot. The first portion includes a first opening and a first profile on an edge of the first opening. The slot extends from the first opening of the first portion to the second portion.

When the blade is in the closed position and selectively locked by the lock, movement of the button towards the first end of the handle selectively releases the lock and the thrust mechanism moves the blade to the open position. The movement of the blade to the open position causes the lock to rotate from an unlocked position to a locked position with the protrusion moving through an arced path within the first opening. In the unlocked position the protrusion is aligned with the slot. In the locked position the protrusion is engaged with the first profile.

The knife may include a spring positioned to bias the lock in the locked position. The lock may include a boss offset from the axis of rotation of the lock. The thrust mechanism may include a trip plate having a ridge. The trip plate is slidable along a length of the handle. Movement of the trip plate along the length of the handle causes the ridge to contact the boss and rotate the lock from the locked positioned to the unlocked position.

The lock may include a first side and a second side opposite the first side with the protrusion extending from the first side and the boss extending from the second side.

The lock may be also rotatable between the unlocked position and a second locked position. The second portion of the stop plate may include a second opening and a second profile on an edge of the second opening. The slot may extend from the first opening of the first portion to the second opening of the second portion. When the blade is in the open position and selectively locked by the lock, movement of the button towards the second end of the handle selectively releases the lock and the thrust mechanism moves the blade to the closed position. The movement of the blade to the closed position causes the lock to rotate from the unlocked position to the second locked position with the protrusion moving through a second arced path within the second opening. In the second locked position the protrusion is engaged with the second profile.

The lock may be configured to rotate from the unlocked position to the locked position in a first direction of rotation and also configured to rotate from the unlocked position to the second locked position in the first direction of rotation. The lock may be configured to rotate a first degree of rotation from the unlocked position to the locked position and configured to rotate the same degree of rotation from the unlocked position to the second locked position.

The lock may include a first boss offset from the axis of rotation of the lock and a second boss offset from the axis of rotation of the lock. The thrust mechanism may include a trip plate having a first ridge and a second ridge. Movement of the trip plate towards the first end of the handle causes the first ridge to contact the first boss and rotate the lock from the locked positioned to the unlocked position. Movement of the trip plate towards the second end of the handle causes the second ridge to contact the second boss and rotate the lock from the second locked position to the unlocked position.

The knife may include a first block configured to slide along the length of the handle and a second block configured to slide along the length of the handle. The first block is biased by a first spring towards the first end of the handle and contacts the second boss when the blade is in the closed position. The second block is biased by a second spring towards the second end of the handle. The second block contacts the first boss when the blade is in the open position.

The lock includes a first side and a second side opposite the first side of the lock. The protrusion may extend from the first side of the lock. The first boss and the second boss may extend from the second side of the lock.

The tang may include a first side, a second side opposite the first side of the tang, and a recessed portion in the first side of the tang with a portion of the lock within the recessed portion and the protrusion, the first boss, and the second boss extending outside the recessed portion.

The tang may include a first side, a second side opposite the first side of the tang, a first opening that extends from the first side of the tang to the second side of the tang and a second opening that extends from the first side of the tang to the second side of the tang. The first boss of the lock may extend through the first opening of the tang and beyond the second side of the tang. The second boss of the lock may extend through the second opening of the tang and beyond the second side of the tang. The lock may be positioned in the recessed portion with the protrusion extending beyond the first side of the tang.

The recessed portion of the tang may form a shaft. The lock is rotatably supported upon the shaft of the tang of the blade. The tang may include an aperture that extends through the shaft from the first side of the tang to the second side of the tang. The knife includes a stop pin having a thrust pin. The thrust pin may extend through the aperture of the tang and beyond the second side of the tang.

An embodiment of an out-the-front knife includes a handle, a blade, a lock, a first profile, and a second profile. The handle has a first end and a second end. The blade is moveable between a closed position and an open position. The blade is positioned within the handle in the closed position. The blade extends from the first end of the handle in the open position. The lock is rotatably connected to the blade. The lock includes a first surface and a second surface. The lock is moveable with the blade along a length of the handle. The second profile is closer to the second end of the handle than the first profile.

When the blade is in the closed position the lock is rotatable between a first position and a second position to selectively lock the blade in the closed position. The first surface of the lock is engaged with the first profile in the first position. When the blade is in the open position the lock is rotatable between a third position and a fourth position to selectively lock the blade in the open position. The second surface of the lock is engaged with the second profile in the fourth position. The lock is slidable from the second position to the third position when the blade moves from the closed position to the open position.

The first surface and the second surface may be positioned on opposing sides of a protrusion of the lock. The second surface may be closer to an axis of rotation of the lock than the first surface.

The knife may include a trip plate and the lock may include a first boss and a second boss. The trip plate is slidable along the length of the handle. Movement of the trip plate towards the first end of the handle contacts the first boss and rotates the lock from the first position to the second position. Movement of the trip plate towards the second end of the handle contacts the second boss and rotates the lock from the fourth position to the third position.

The knife may include a first block and a second block. The first block contacts the first boss during movement of the blade to the open position and rotates the lock from the third position to the fourth position. The second block contacts the second boss during movement of the blade to the closed position and rotates the lock from the second position to the first position.

An embodiment of a knife includes a handle, a blade, and a lock rotatable to selectively lock the blade in the open position and selectively lock the blade in the closed position. The handle has a first locking surface and a second locking surface. The blade has a tang. The blade is configured to move between a closed position within the handle and an open position with the blade extending beyond the handle. The lock is rotatably supported upon the tang. The lock includes a protrusion having a first surface and a second surface. Rotation of the lock in the open position engages the first surface of the protrusion with the first locking surface of the handle to lock the blade in the open position. Rotation of the lock in the closed position engages the second surface of the protrusion with the second locking surface of handle to lock the blade in the closed position.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a partially exploded view of an embodiment of an out-the-front knife.

FIG. 2A is a bottom view of an embodiment of a stop plate and a lock.

FIG. 2B is a top view of an embodiment of a stop plate and a lock.

FIG. 3 is an exploded view of a blade, a lock, and a stop pin.

FIG. 4 is a partial view of the blade, the lock, the stop pin, and the stop plate with the lock in a locked position.

FIG. 5 shows an embodiment of a thrust mechanism.

FIG. 6A is a partial view of an embodiment of an out-the-front knife with the lock in a closed, locked position.

FIG. 6B is a cross-sectional view of an embodiment of the out-the-front knife with the lock in a closed, locked position.

FIG. 7A is a partial view of an embodiment of an out-the-front knife with the lock in a closed, unlocked position with the thrust mechanism positioned to move the blade from the closed position to the open position.

FIG. 7B is a cross-sectional view of an embodiment of an out-the-front knife with the lock in a closed, unlocked position with the thrust mechanism positioned to move the blade from the closed position to the open position.

FIG. 8A is a partial view of an embodiment of an out-the-front knife with the lock in an open, unlocked position.

FIG. 8B is a cross-sectional view of an embodiment of an out-the-front knife with the lock in an open, unlocked position.

FIG. 9A is a partial view of an embodiment of an out-the-front knife with the lock in an open, locked position.

FIG. 9B is a cross-sectional view of an embodiment of an out-the-front knife with the lock in an open, locked position.

FIG. 10A is a partial view of an embodiment of an out-the-front knife with the lock in an open, unlocked position with the thrust mechanism positioned to move the blade from the open position to the closed position.

FIG. 10B is a cross-sectional view of an embodiment of an out-the-front knife with the lock in an open, unlocked position with the thrust mechanism positioned to move the blade from the open position to the closed position.

FIG. 11A is a partial view of an embodiment of an out-the-front knife with the lock in a closed, unlocked position.

FIG. 11B is a cross-sectional view of an embodiment of an out-the-front knife with the lock in a closed, unlocked position.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

### DETAILED DESCRIPTION

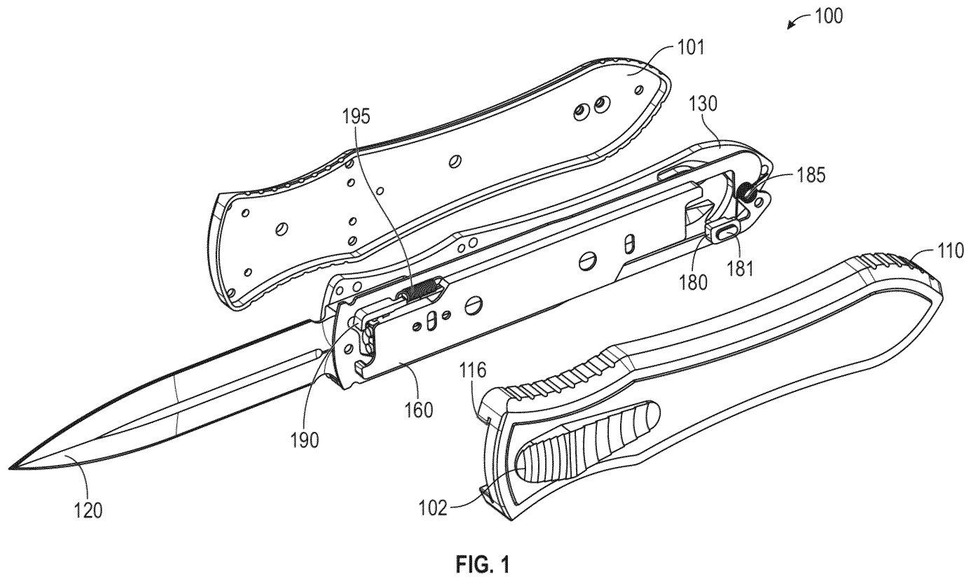

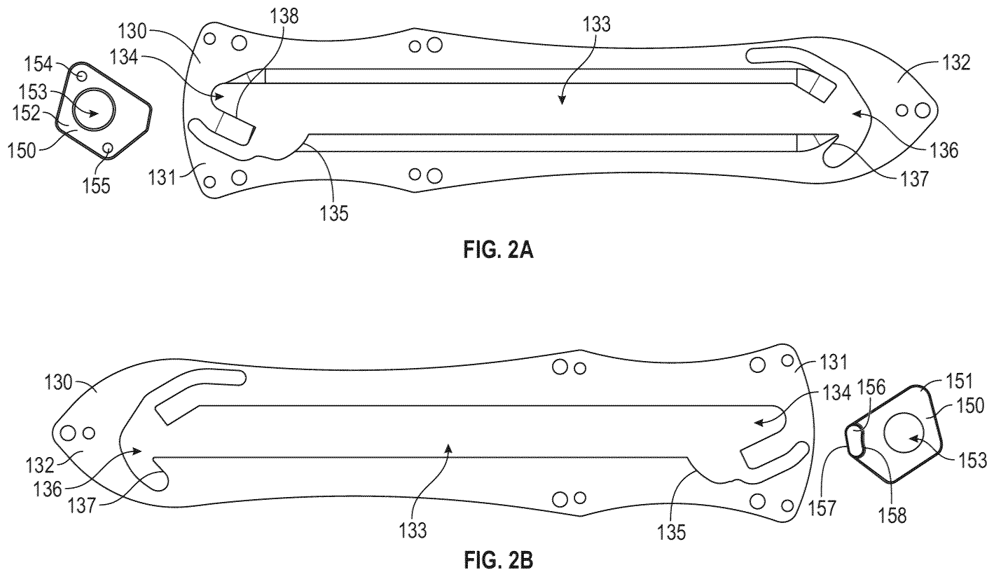

FIG. 1 is a partially exploded view of an embodiment of an out-the-front knife 100. The knife 100 includes a handle 110. The handle 110 includes a detachable cover 101 to facilitate assembly. The knife 100 includes a button 102, a blade 120, a stop plate 130, a lock 150 (shown in FIGS. 2A, 2B), and a thrust mechanism 160 that are contained within the handle 110. The button 102 is moveable, such as slideable along a length of the handle 110, to actuate the thrust mechanism 160. The handle 110 includes a blade slot 116 that provides an opening for the blade 120 to extend therefrom. The blade 120 is moveable by the thrust mechanism 160 from a closed position where the blade 120 and tang 122 are entirely within the handle 110 and an open position where the blade 120 extends from the handle 110. The knife 100 also includes a first block 180 and a spring 185 for biasing the lock 150 in a locked, closed position and/or a second block 190 and spring 195 for biasing the lock 150 in a locked, open position.

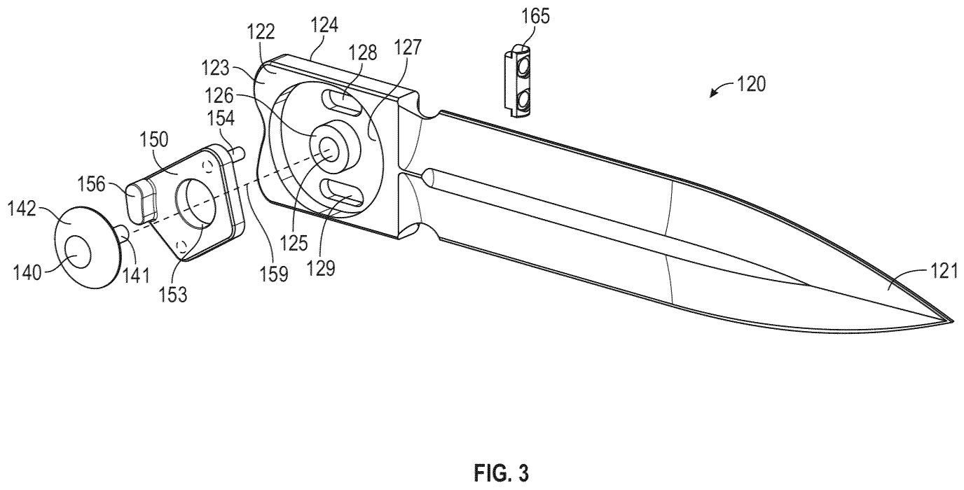

FIGS. 2A and 2B show opposing sides of an embodiment of the stop plate 130 and an embodiment of the lock 150. The stop plate 130 may be attachable to the handle 110 or may be integrally formed into the handle 110, such as into detachable cover 101. The stop plate 130 includes a first portion 131 associated with a first end of the stop plate 130 and a second portion 132 associated with a second end of the stop plate 130. The first portion 131 includes a first opening 134 and a first profile 135 on an edge of the first opening 134. The first portion 131 may also include a pin stop surface 138 shaped to engage with a stop pin 140 (shown in FIG. 3). The second portion 132 includes a second opening 136 and a second profile 137 on an edge of the second opening 136. Each of the first opening 134 and the second opening 136 are shaped to accommodate arced paths for a portion of the lock 150, as discussed below. The stop plate 130 includes a slot 133 extending from the first opening 134 of the first portion 131 to the second opening 136 of the second portion 132. In some embodiments, the first profile 135 and/or the second profile 137 may have a concave shape. In some embodiments, the first profile 135 and/or the second profile 137 may have a convex shape. In some embodiments, one of the first profile 135 and the second profile 137 may have a convex shape, and the other may have a concave shape.

As shown in FIGS. 2A and 2B, the first profile 135 and the second profile 137 are linearly aligned with each along a width of the stop plate 130. In other words, the first profile 135 and the second profile 137 are both positioned on the same side of the slot 133.

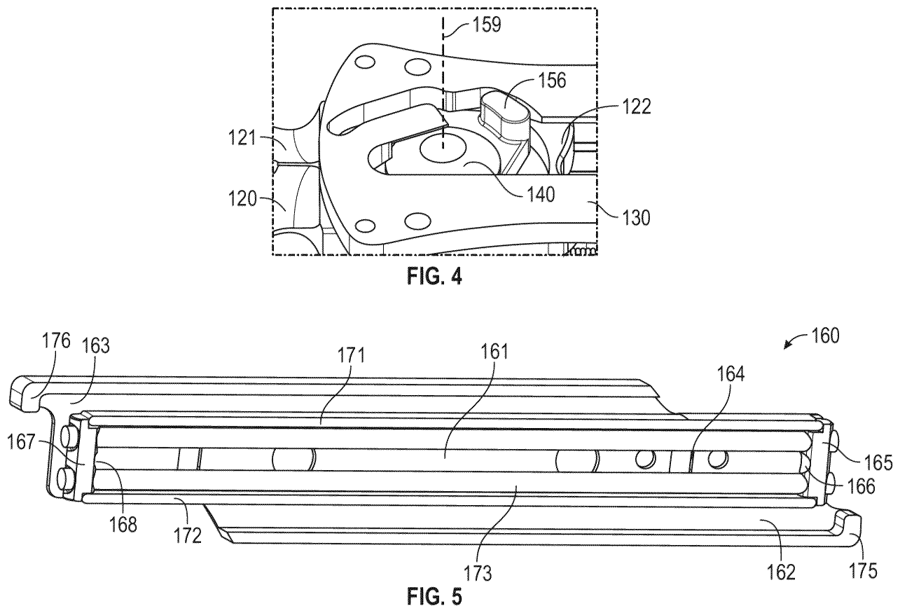

The lock 150 is rotatable about an axis of rotation 159 (shown in FIG. 3 and FIG. 4) to selectively lock the blade 120 (shown in FIG. 1) in the open position and selectively lock the blade 120 in the closed position. The axis of rotation 159 extends through the tang 122 of the blade 120. The lock 150 includes a first surface 157 shaped to engage with the first profile 135 of the stop plate 130 and a second surface 158 shaped to engage with the second profile 137 of the stop plate 130 to selectively lock the blade 120 in either the open position or the closed position. For example, the first profile 135 may have a concave shape that corresponds to a convex shape of the first surface 157 of the lock 150.

The lock 150 includes a first side 151 and a protrusion 156. The protrusion 156 extends from the first side 151. The first surface 157 and the second surface 158 are positioned on the protrusion 156. The first surface 157 and the second surface 158 may be diametrically aligned with the axis of rotation 159 of the lock 150. The second surface 158 is closer to the axis of rotation 159 than the first surface 157. The protrusion 156 is offset from the axis of rotation 159 so that it moves in an arced path around the axis of rotation 159.

The lock 150 includes a second side 152 opposite the first side 151. The lock 150 may include a first boss 154 and a second boss 155. The first boss 154 and/or the second boss 155 may extend from the second side 152 of the lock 150. Each of the first boss 154 and the second boss 155 are offset from the axis of rotation 159 so that they move in an arced path around the axis of rotation 159. The axis of rotation 159 may be positioned between the first boss 154 and the second boss 155. The lock 150 may include an aperture 153 with the axis of rotation 159 extending through the aperture 153. The parts of the lock 150 are formed as a unibody piece or are rigidly connected so that the first boss 154, the second boss 155, and the protrusion 156 move together.

FIG. 3 shows an exploded view of the blade 120, the stop pin 140, and the lock 150. The blade 120 includes an integral tang 122 on one end and a cutting edge 121 at the other end. The lock 150 is rotatable supported on the tang 122 of the blade 120 and moves along the length of the handle 110 (shown in FIG. 1) with the blade 120. In some embodiments, the lock 150 is located within the tang 122 with only the protrusion 156, the first boss 154, and the second boss 155 extending beyond the sides 123, 124 of the tang 122.

The tang 122 of the blade 120 includes a first side 123, a second side 124 opposite the first side 123, a first opening 128 between the first side 123 to the second side 124, and a second opening 129 between the first side 123 to the second side 124. The first boss 154 extends through the first opening 128 of the tang 122 and beyond the second side 124 of the tang 122. The second boss 155 extends through the second opening 129 of the tang 122 and beyond the second side 124 of the tang 122.

The tang 122 may include a recessed portion 127 in the first side 123. It is desirable to position a portion of the lock 150 within the recessed portion 127 of the tang 122 in order to provide a more compact design. The first opening 128 and second opening 129 are in communication with the recessed portion 127. The lock 150 is positioned within the recessed portion 127 with the first boss 154 and the second boss 155 extending beyond the second side 124 of the tang 122 and the protrusion 156 extending beyond the first side 123 of the tang 122. In some embodiments, the recessed portion 127 may form a shaft 126. The shaft 126 is shaped to receive the aperture 153 of the lock 150 and allow the lock 150 to rotate upon tang 122. The tang 122 may include an aperture 125 extending from the first side 123 to the second side 124.

The stop pin 140 includes a thrust pin 141. The thrust pin 141 engages with a first thrust block 165 of the thrust mechanism 160 and a second thrust block 167 (shown in FIG. 5). The thrust pin 141 may extend through the aperture 125 in the tang 122 and beyond the second side 124 of the tang 122. The stop pin 140 may include a stop cone 142 connected to the thrust pin 141. The stop cone 142 is shaped to engage with the pin stop surface 138 of the stop plate 130. As shown in FIG. 4, the stop pin 140 engages with the stop plate 130 to inhibit lateral and upward movement of the blade 120. The protrusion 156 of the lock 150 engages another portion of the stop plate 130 to inhibit linear (along the length of the handle 110) movement of the blade 120. The stop pin 140 may remain stationary while the lock 150 rotates on the tang 122 to selectively lock the blade 120.

FIG. 5 shows an embodiment of the thrust mechanism 160. The thrust mechanism 160 moves the blade between the closed position and the open position. The thrust mechanism 160 includes a trip plate 161, a first thrust block 165, a second thrust block 167, and one or more thrust springs 173 extending between the first thrust block 165 and the second thrust block 167. The first thrust block 165 includes an indentation 166 to receive the thrust pin 141 (shown in FIG. 3) when the blade 120 is in the open position. The second thrust block 167 includes an indentation 168 to receive the thrust pin 141 (shown in FIG. 3) when the blade is in the closed position.

The trip plate 161 is slidable along the length of the handle 110. The button 102 (shown in FIG. 1) extends through the handle 110 and connects to the trip plate 161. In some embodiments, the button 102 is connected to the trip plate 161 via a button opening 164 in the trip plate 161. The trip plate 161 includes a first end 162 and a second end 163. The first thrust block 165 is positioned at the first end 162 and the second thrust block 167 is positioned at the second end 163. The trip plate 161 may include a first rail 171 and a second rail 172 extending from the first end 162 to the second end 163. The first rail 171 and the second rail 172 support the first thrust block 165 and the second thrust block 167. The trip plate 161 includes a ridge 175 at the first end 162 and a ridge 176 at the second end 163.

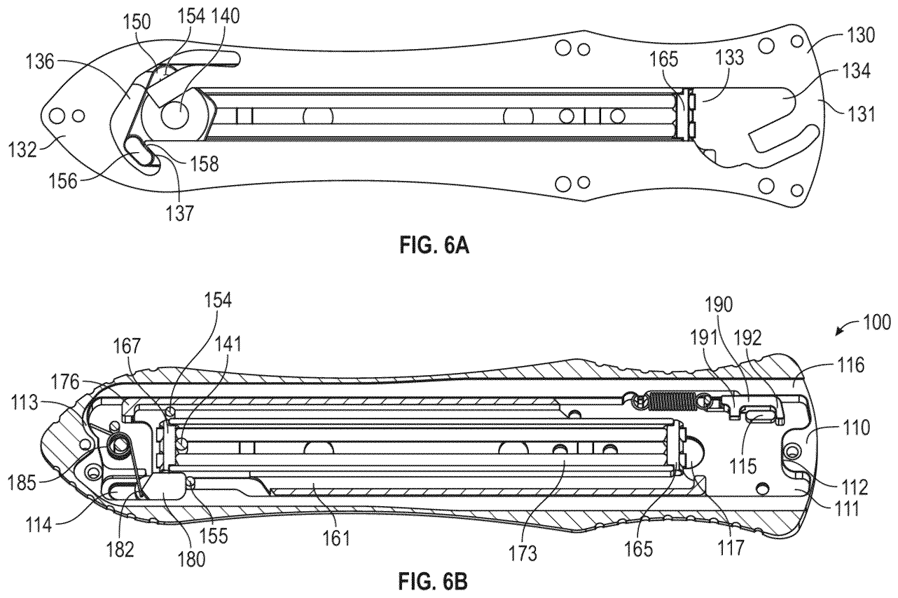

FIG. 6A-11B illustrate operation of the knife 100 and the selective locking of the blade 120 by the lock 150. These figures are intended to illustrate the relative movement of parts and are not necessarily drawn to scale. For purposes of illustration, FIGS. 6A, 7A, 8A, 9A, 10A, and 11A show the interaction between the stop plate 130, the stop pin 140, the lock 150. The stop plate 130 includes the first opening 134 in the first portion 131 and the second opening 136 in the second portion to accommodate rotation of the protrusion 156 of the lock 150. The protrusion 156 extends into and moves within the slot 133, the first opening 134, and the second opening 136.

FIGS. 6B, 7B, 8B, 9B, 10B, and 11B show the corresponding cross-sectional views to illustrate the position of the trip plate 161, as well as the first boss 154 and the second boss 155 of the lock 150. The handle 110 includes a cavity 111, a first end 112, and a second end 113. A length of the handle 110 extends from the first end 112 to the second end 113. The trip plate 161 is positioned within the cavity 111 and is slideable along the length of the handle 110. The thrust pin 141 of the stop pin 140 is positioned between the first thrust block 165 and the second thrust block 167. The first boss 154 is linearly positioned between the ridge 176 at the second end 163 of the trip plate 161 and the block 190. The second boss 155 is linearly positioned between the ridge 175 at the first end 162 of the trip plate 161 and the block 180. The button 102 (shown in FIG. 1) extends through a button slot 117 in the handle 110 and connects to the trip plate 161.

FIG. 6A is a partial view and FIG. 6B is a cross-sectional view of the knife 100 with the lock 150 in a closed, locked position. In the closed, locked position, the second surface 158 of the protrusion 156 engages with the second profile 137 on the edge of the second opening 136 of the stop plate 130. A linear force is placed on the second boss 155 of the lock 150 (shown in FIG. 6B) to bias the lock 150 in its rotated, locked position. The force upon the second boss 155 would cause counter-clockwise rotation of the lock 150, but further rotation of the lock 150 is inhibited by the interaction between the second surface 158 and second profile 137. By way of example, the linear force may be placed on the second boss 155 via the block 180.

The block 180 includes a protrusion 181 (shown in FIG. 1) on one side and is positioned within a groove 114 in the handle 110. The block 180 can move along the length of the groove 114 along a portion of the length of the handle 110. A spring 185 biases the block 180 towards the first end 112 of the handle 110. The spring 185 may be a torsion spring. The block 180 may include a point 182 oriented towards the second end 113 of the handle 110 to maintain contact with the torsion spring 185.

When an operator desires to operate the knife 100 to deploy the blade, the button 102 (shown in FIG. 1) is moved towards the first end 112 of the handle 110. The movement of the button 102 slides the trip plate 161 towards the first end 112 of the handle 110 and selectively releases the lock 150. The second thrust block 167 is held in place by the thrust pin 141 and the first thrust block 165 is carried with the trip plate 161, which stretches (i.e. loads) the thrust springs 173. As the trip plate 161 moves towards the first end 112 of the handle 110, the distance between the first boss 154 and the ridge 176 at the second end 163 of the trip plate 161 decreases. When the ridge 176 contacts the first boss 154, the lock 150 is forced to rotate in a clockwise direction until the protrusion 156 is disengaged from the second profile 137 of the stop plate 130.

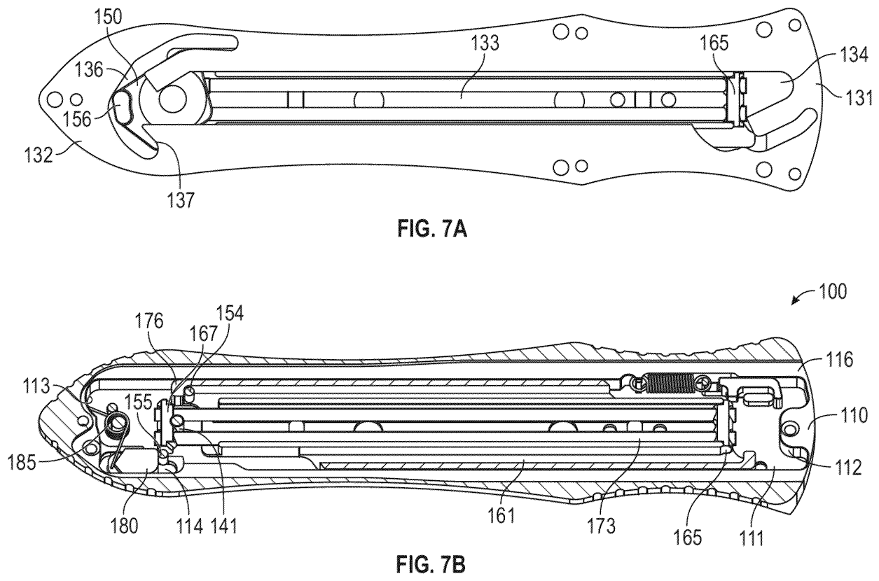

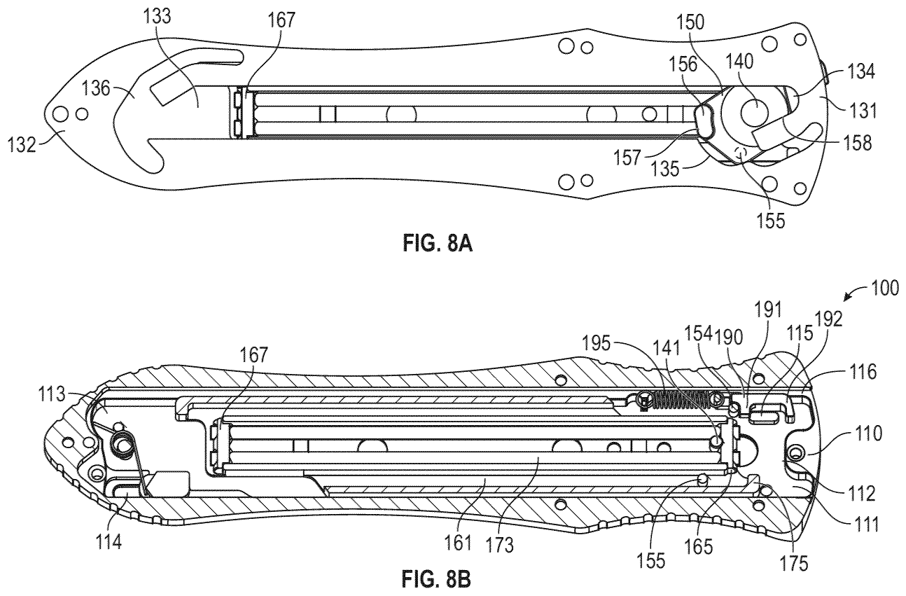

The lock 150 rotates in a clockwise direction with the protrusion 156 travelling in an arced path until it is aligned with the slot 133 of the stop plate 130 as shown in FIGS. 7A and 7B. In this position, the knife 100 is still closed, but is unlocked in preparation for movement of the blade 120 (shown in FIG. 1). As best seen in FIG. 7B, the rotation of the lock 150 also overcomes the force created by the spring 185 on the second boss 155. At this point, the thrust springs 173 are stretched and the lock 150 is no longer holding the blade 120 in the closed position. Accordingly, the second thrust block 167 is pulled by the thrust springs 173 towards the first end 112. The blade 120 is carried by the second thrust block 167 via the engagement of the thrust pin 141 with the second thrust block 167, which moves the blade 120 within blade slot 116 from the closed position (contained entirely within the handle 110) to the open position (extending from the first end 112), which is shown in FIGS. 8A and 8B.

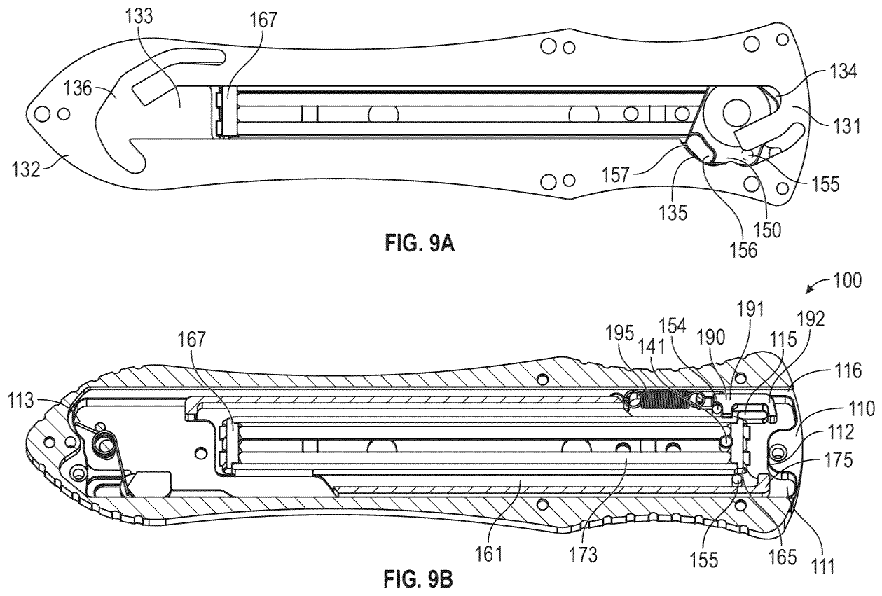

As shown in FIGS. 8A and 8B, the blade 120 has carried the lock 150 from the second end 113 to the first end 112. The knife 100 is in the open position, but not yet locked. The movement of the lock 150 causes the first boss 154 of the lock 150 to contact a first stop 191 of the block 190. The momentum of the lock 150 traveling from the second end 113 to the first end 112 is converted into counter-clockwise rotation by the engagement of the first boss 154 with the first stop 191 of the block 190. The lock 150 rotates until the first surface 157 of the protrusion 156 is aligned with the first profile 135 of the stop plate 130 as shown in FIGS. 9A and 9B. The protrusion 156 rotates through an arced path in the first opening 134.

FIG. 9A is a partial view and FIG. 9B is a cross-sectional view of an embodiment of the knife 100 with the lock 150 in an open, locked position. In the open, locked position, the first surface 157 of the protrusion 156 engages with the first profile 135 on the edge of the first opening 134 of the stop plate 130. A linear force is placed on the first boss 154 of the lock 150 (shown in FIG. 9B) to bias the lock 150 in its rotated, locked position. The force upon the first boss 154 would cause counter-clockwise rotation of the lock 150, but further rotation of the lock 150 is inhibited by the interaction between the first surface 157 and the first profile 135. By way of example, the linear force may be placed on the first boss 154 via the block 190.

As shown in FIG. 9B, the block 190 includes a first stop 191 and a second stop 192. The handle 110 includes a protrusion 115 near the first end 112 and extending upwards between the first stop 191 and the second stop 192 to limit the extent of linear movement of the block 190. The first stop 191 is positioned to engage with the first boss 154 of the lock 150. A spring 195 biases the block 190 towards the second end 113 of the handle 110. The spring 195 may be a linear spring.

When an operator desires to operate the knife 100 to retract the blade, the button 102 (shown in FIG. 1) is moved towards the second end 113 of the handle 110. The movement of the button 102 slides the trip plate 161 towards the first end 112 of the handle 110 and selectively releases the lock 150. The first thrust block 165 is held in place by the thrust pin 141 and the second thrust block 167 is carried with the trip plate 161, which stretches the thrust springs 173. As the trip plate 161 moves towards the second end 113 of the handle 110, the distance between the second boss 155 and the ridge 175 at the first end 162 of the trip plate 161 decreases. When the ridge 175 contacts the second boss 155, the lock 150 is forced to rotate in a clockwise direction until the protrusion 156 is disengaged from the first profile 135 of the stop plate 130.

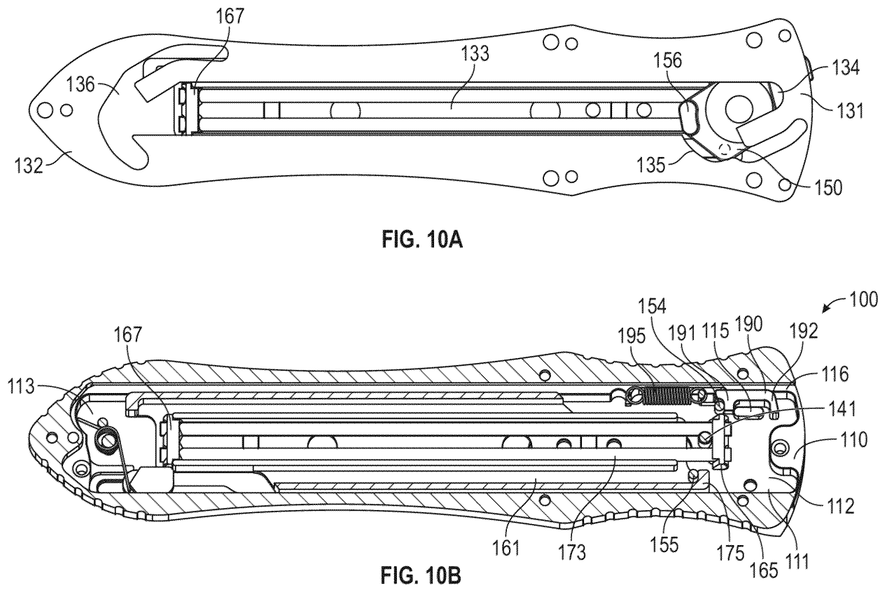

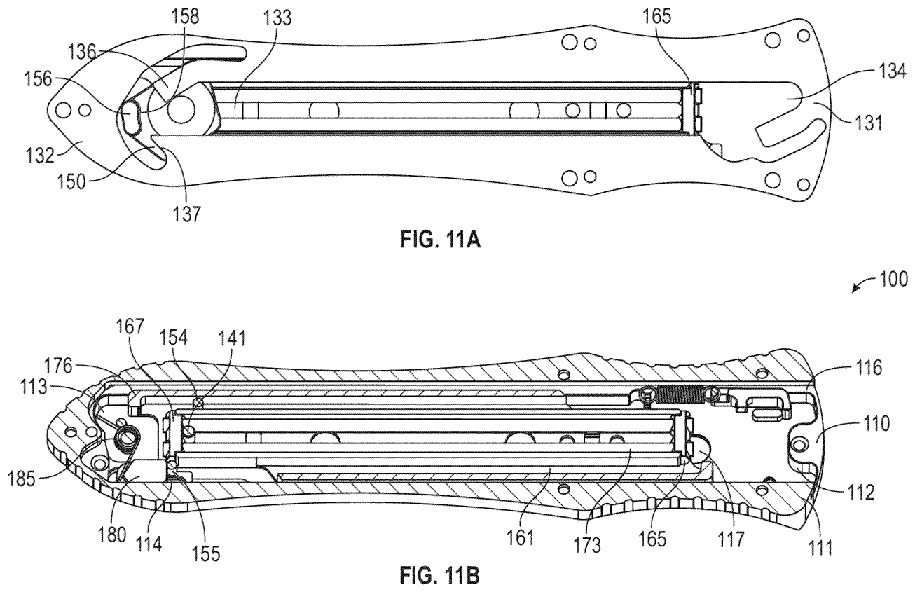

The lock 150 rotates in a clockwise direction with the protrusion 156 travelling in an arced path until it is aligned with the slot 133 of the stop plate 130 as shown in FIGS. 10A and 10B. In this position, the knife 100 is still open, but is unlocked in preparation for movement of the blade 120 (shown in FIG. 1). As best seen in FIG. 10B, the rotation of the lock 150 also overcomes the force created by the spring 195 on the first boss 154. At this point, the thrust springs 173 are stretched and the lock 150 is no longer holding the blade 120 in the open position. Accordingly, the first thrust block 165 is pulled by the thrust springs 173 towards the second end 113. The blade 120 is carried by the first thrust block 165 via the engagement of the thrust pin 141 with the first thrust block 165, which moves the blade 120 within blade slot 116 from the open position (extending from the first end 112) to the closed position (contained entirely within the handle 110), which is shown in FIGS. 11A and 11B.

As shown in FIGS. 11A and 11B, the blade 120 has carried the lock 150 from the first end 112 to the second end 113. The knife 100 is in the open position, but not yet locked. The movement of the lock 150 causes the second boss 155 of the lock 150 to contact the block 180. The momentum of the lock 150 traveling from the first end 112 to the second end 113 is converted into counter-clockwise rotation by the engagement of the second boss 155 with the block 180. The lock 150 rotates until the second surface 158 of the protrusion 156 is aligned with the second profile 137 of the stop plate 130 as shown in FIGS. 6A and 6B. The protrusion 156 rotates through an arced path in the second opening 136. In some embodiments, the degree of rotation through the first arced path (from FIG. 8A to FIG. 9A) is the same degree of rotation through the second arced path (from FIG. 11A to FIG. 6A).

According to the embodiment shown in FIGS. 6A-11B, the lock 150 is rotatable from an unlocked position (shown in FIG. 8A and FIG. 11A) to either a first locked position (shown in FIG. 9A) where the first surface 157 of the protrusion 156 is engaged with the first profile 135 of the stop plate 130 and a second locked position (shown in FIG. 6A) where second surface 158 of the protrusion 156 is engaged with the second profile 137 of the stop plate 130. In between the two locked positions, the lock 150 is moveable between two unlocked positions: an unlocked, closed position and an unlocked, open position.

It is appreciated that various modifications may be made while still obtaining the benefits of the described embodiments. For example, instead of the first boss 154 and the second boss 155 extending through the tang 122, the protrusion may extend through a single opening in the tang 122.

Also for example, the block 180 with torsion spring 185 and block 190 with linear spring 195 are interchangeable. For instance, a torsion spring may be used with the block 190, a linear spring may be used with the block 180, a groove and a protrusion may be used to guide linear movement of the block 190, and a protrusion in the handle and a second stop may be used with the block 180.

Reference throughout this specification to “an embodiment” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. It will be apparent to those having skill in the art that changes may be made to the details of the above-described embodiments without departing from the underlying principles of the present disclosure.

1. A knife comprising:
a handle having a first end and a second end;
a button moveable along the handle;
a blade with an integral tang, the blade and the tang are moveable between a closed position and an open position, the blade and the tang are positioned within the handle in the closed position, and the blade extends from the first end of the handle in the open position;
a thrust mechanism configured to move the blade between the closed position and the open position;
a lock rotatably supported on the tang of the blade and configured to rotate about an axis of rotation, the lock having a protrusion offset from the axis of rotation of the lock; and
a stop plate including a first end, a second end, a first portion associated with the first end of the stop plate, a second portion associated with the second end of the stop plate, and a slot, the first portion including a first opening and a first profile on an edge of the first opening, the slot extends from the first opening of the first portion to the second portion; and
wherein when the blade is in the closed position and selectively locked by the lock, movement of the button towards the first end of the handle selectively releases the lock and the thrust mechanism moves the blade to the open position, and the movement of the blade to the open position causes the lock to rotate from an unlocked position to a locked position with the protrusion moving through an arced path within the first opening, in the unlocked position the protrusion is aligned with the slot, and in the locked position the protrusion is engaged with the first profile.

2. The knife of claim 1, wherein the lock includes a boss offset from the axis of rotation of the lock, and wherein the thrust mechanism includes a trip plate having a ridge, the trip plate is slidable along a length of the handle, wherein movement of the trip plate along the length of the handle causes the ridge to contact the boss and rotate the lock from the locked positioned to the unlocked position.

3. The knife of claim 2, wherein the lock includes a first side and a second side opposite the first side, the protrusion extends from the first side, the boss extends from the second side.

4. The knife of claim 1, further comprising a spring positioned to bias the lock in the locked position.

5. The knife of claim 1, wherein the lock is rotatable between the unlocked position and a second locked position;
the second portion of the stop plate includes a second opening and a second profile on an edge of the second opening, the slot extends from the first opening of the first portion to the second opening of the second portion; and
when the blade is in the open position and selectively locked by the lock, movement of the button towards the second end of the handle selectively releases the lock and the thrust mechanism moves the blade to the closed position, and movement of the blade to the closed position causes the lock to rotate from the unlocked position to the second locked position with the protrusion moving through a second arced path within the second opening, in the second locked position the protrusion is engaged with the second profile.

6. The knife of claim 5, wherein the lock is configured to rotate from the unlocked position to the locked position in a first direction of rotation and the lock is configured to rotate from the unlocked position to the second locked position in the first direction of rotation.

7. The knife of claim 6, wherein the lock is configured to rotate a first degree of rotation from the unlocked position to the locked position and the lock is configured to rotate a second degree of rotation from the unlocked position to the second locked position, the first degree of rotation is the same as the second degree of rotation.

8. The knife of claim 5, wherein the lock includes a first boss offset from the axis of rotation of the lock and a second boss offset from the axis of rotation of the lock, and wherein the thrust mechanism includes a trip plate having a first ridge and a second ridge, the trip plate is slidable along a length of the handle, wherein movement of the trip plate towards the first end of the handle causes the first ridge to contact the first boss and rotate the lock from the locked positioned to the unlocked position, and movement of the trip plate towards the second end of the handle causes the second ridge to contact the second boss and rotate the lock from the second locked position to the unlocked position.

9. The knife of claim 8, further comprising:
a first block configured to slide along the length of the handle, the first block is biased by a first spring towards the first end of the handle, the first block contacts the second boss when the blade is in the closed position; and
a second block configured to slide along the length of the handle, the second block is biased by a second spring towards the second end of the handle, the second block contacts the first boss when the blade is in the open position.

10. The knife of claim 8, wherein the lock includes a first side and a second side opposite the first side of the lock, the protrusion extends from the first side of the lock, the first boss and the second boss extend from the second side of the lock.

11. The knife of claim 10, wherein the tang includes a first side, a second side opposite the first side of the tang, a first opening that extends from the first side of the tang to the second side of the tang and a second opening that extends from the first side of the tang to the second side of the tang, the first boss of the lock extends through the first opening of the tang and beyond the second side of the tang, the second boss of the lock extends through the second opening of the tang and beyond the second side of the tang.

12. The knife of claim 11, wherein the tang further includes a recessed portion in the first side of the tang, a portion of the lock is within the recessed portion, the protrusion extends beyond the first side of the tang.

13. The knife of claim 12, wherein the recessed portion of the tang forms a shaft, the lock is rotatably supported upon the shaft of the tang of the blade.

14. The knife of claim 13, wherein the tang includes an aperture that extends through the shaft from the first side of the tang to the second side of the tang, and the knife further comprises a stop pin having a thrust pin, the thrust pin extends through the aperture of the tang and beyond the second side of the tang.

15. The knife of claim 8, wherein the tang includes a first side, a second side opposite the first side, and a recessed portion in the first side, a portion of the lock is within the recessed portion, and
wherein the protrusion, the first boss, and the second boss extend outside the recessed portion.

16. An out-the-front knife comprising:
a handle having a first end and a second end;
a blade that is moveable between a closed position and an open position, the blade is positioned within the handle in the closed position, and the blade extends from the first end of the handle in the open position;
a lock that is rotatably connected to the blade, the lock including a first surface and a second surface, the lock moveable with the blade along a length of the handle;
a first profile; and
a second profile, the second profile closer to the second end of the handle than the first profile,
wherein when the blade is in the closed position the lock is rotatable between a first position and a second position to selectively lock the blade in the closed position, the first surface of the lock is engaged with the first profile in the first position, and
when the blade is in the open position the lock is rotatable between a third position and a fourth position to selectively lock the blade in the open position, the second surface of the lock is engaged with the second profile in the fourth position, and the lock is slidable from the second position to the third position when the blade moves from the closed position to the open position.

17. The out-the-front knife of claim 16, wherein the lock further comprises a protrusion, the first surface and the second surface are positioned on opposing sides of the protrusion, the second surface is closer to an axis of rotation of the lock than the first surface.

18. The out-the-front knife of claim 17, further comprising a trip plate, and wherein the lock further comprises a first boss and a second boss, the trip plate is slidable along the length of the handle, wherein movement of the trip plate towards the first end of the handle contacts the first boss and rotates the lock from the first position to the second position, and movement of the trip plate towards the second end of the handle contacts the second boss and rotates the lock from the fourth position to the third position.

19. The out-the-front knife of claim 18, further comprising a first block and a second block, wherein the first block contacts the first boss during movement of the blade to the open position and rotates the lock from the third position to the fourth position, and the second block contacts the second boss during movement of the blade to the closed position and rotates the lock from the second position to the first position.

20. A knife comprising:
a handle having a first locking surface and a second locking surface;
a blade with a tang, the blade is configured to move between a closed position within the handle and an open position with the blade extending beyond the handle; and
a lock rotatable to selectively lock the blade in the open position and selectively lock the blade in the closed position, the lock rotatably supported upon the tang, the lock including a protrusion having a first surface and a second surface, wherein rotation of the lock in the open position engages the first surface of the protrusion with the first locking surface of the handle to lock the blade in the open position, and rotation of the lock in the closed position engages the second surface of the protrusion with the second locking surface of handle to lock the blade in the closed position.
